(19) United States
(12) Patent Application Publication
(10) Pub. No.: US 2007/0027286 A1
(43) Pub. Date: Feb. 1, 2007

(54) Silicone composition which can be crosslinked by means of dehydrogenative condensation in the presence of a metal catalyst

(76) Inventors: Delphine Blanc-Magnard, Lyon (FR); Sebastien Sterin, Saint Cyr Au Mont D'Or (FR)

Correspondence Address: BUCHANAN, INGERSOLL & ROONEY PC, POST OFFICE BOX 1404, ALEXANDRIA, VA, 22313-1404, US

(21) Appl. No.: 10/563,326

(22) PCT Filed: Jun. 25, 2004
(86) PCT No.: PCT/FR04/01616

§ 371 Date: May 10, 2006

(30) Foreign Application Priority Data
Jun. 30, 2003 (FR) 03/07908

(51) Int. Cl. C08G 77/08

(52) U.S. Cl. 528/31; 528/14; 528/23; 525/478

(57) ABSTRACT

The invention relates to a silicone composition which can be crosslinked by dehydrogenative condensation between reactive ≡SiH and ≡SiOH units and which employs a catalytic iridium complex capable of being obtained by reacting together: on the one hand, an iridium complex of formula (I):
(IrΣΣ′₂)ₙ in which: A/ n is 1 or 2 and: if n is 1, Σ is a 3-electron radical ligand LX, if n is 2, Σ is a 1-electron radical ligand X which behaves like a 3-electron ligand LX with the two iridium atoms, B/ Σ′, which are identical or different, preferably identical, each represent a 2-electron ligand L,
on the other hand, a ligand Σ_{d} chosen from R₂S, R₂O, NR₃, carbenes and organophosphorus compounds.

The present invention relates to silicone compositions which can be crosslinked by dehydrogenative condensation between reactive ≡SiH and ≡SiOH units and which employ an iridium complex as catalyst. It also relates to a preparation process relating thereto, to the crosslinked materials thus obtained and to the articles coated with or composed of these materials.

The invention thus relates to the field of the catalysis of dehydrogenative condensation reactions which make possible silicone polymerization/cross-linking. The reactive entities involved are monomers, oligomers and/or polymers of polyorganosiloxane (POS) nature.

The reactive units concerned in these entities are, on the one hand, the ≡SiH units and, on the other hand, the ≡SiOH units. Dehydrogenative condensation between these silicone reactive units and entities results in the formation of ≡Si—O—Si≡ bonds and in the release of hydrogen gas. This dehydrogenative condensation is an alternative to the polymerization/crosslinking routes known in the field of silicones, namely the ≡SiH/≡Si-alkenyl (vinyl) polyaddition route and the ≡SiOR/≡SiOR (with R=alkyl) polycondensation route. All these polymerization/crosslinking routes result in more or less polymerized and more or less crosslinked silicone products which can constitute products usable in multiple applications: adhesives, leaktightness products, pointing products, adhesion finishes, release coatings, foams, and the like.

The applications more particularly targeted by the invention are crosslinked silicone elastomer coatings of use as release coatings on various solid supports, for example flexible fibrous supports (made of paper or fabric, e.g.) or flexible nonfibrous supports, such as polymer films (polyester or polyolefin, e.g.) or alternatively supports made of aluminum or of any other metal, such as tin plate.

Another application to which the invention more especially relates is targeted at crosslinked silicone foams.

The dehydrogenative condensation reaction involves metal catalysts based on platinum, rhodium, palladium, ruthenium, boron or iridium, platinum catalysts being the most common (FR-B-1 209 131, U.S. Pat. No. 4,262 107, EP-A-1 167 424 and FR-A-2 806 930).

FR-B-1 209 131 discloses in particular the reaction between a silanol Ph₂Si(OH)₂ and a diorgano-siloxane [(Me₂HSi)₂O], with Me=methyl and Ph=phenyl, by dehydrogenative condensation in the presence of chloroplatinic acid (H₂PtCl₆.6H₂O), which results in a polydiorganosiloxane possessing a D unit, —R₂SiO₂/₂—, of dimethyl or diphenyl type. This reaction produces a rapid evolution of hydrogen.

U.S. Pat. No. 4,262,107 relates to a silicone composition of polyorganosiloxane (POS) type comprising more specifically a polydimethyldisiloxane possessing silanol ends and a crosslinking agent composed of a POS possessing ≡SiH units in the chain and possessing trimethylsilyl ends, a catalyst composed of a rhodium complex (RhCl₃[(C₈H₁₇)₂S]₃), and a crosslinking inhibitor (for example, diethyl maleate, diethyl acetylenedi-carboxylate, triallyl isocyanurate or vinyl acetate).

EP-A-1 167 424 and US-A-2002/0013441 disclose the production of linear block silicone copolymers by dehydrogenative condensation of POS polymers possessing silanol ends and of aromatic POS possessing ≡SiH ends in the presence of a metal catalyst. Hydrosilylation catalysts are suitable and it is possible to employ the metals platinum, rhodium, palladium, ruthenium and iridium, preferably platinum, and compounds of these metals. The hydrosilylation catalyst is in particular a platinum complex, such as the Karstedt catalyst.

FR-A-2 806 930 relates to the use of boron derivatives of tris(pentafluorophenyl)borane type.

It would be of great usefulness to have available a broader panel of dehydrogenative condensation catalysts and in particular of catalysts which make it possible to optimize the kinetics of the reaction and the concentration/effectiveness of the catalyst ratio. An object of the invention is thus to provide novel dehydrogenative condensation catalysts which are particularly effective.

Another object of the invention is to provide catalysts with a lower cost price than platinum catalysts.

Another object of the invention is to provide a panel of catalysts which are easy to prepare, so as to more readily present the catalyst which is the best suited to such and such a reaction and/or under such and such operating conditions.

Another object of the invention is to provide catalysts having moderate activation temperatures (mobilization of a small amount of energy for the catalysis of the dehydrogenative condensation: θ° C.<150° C.) and/or making possible better control of the evolution of hydrogen gas and of the quality of the polymerized product and/or of the crosslinked network, and/or, finally, making it possible to limit the side reactions.

Another essential object of the present invention is to provide ≡SiH/≡SiOH silicone compositions which can be polymerized or crosslinked by dehydrogenative condensation in the presence of such a catalyst.

Patent application PCT/FR02/01340, filed on 18 Apr. 2002 (and unpublished at the date of filing of the present application), discloses silicone compositions which crosslink by dehydrogenative condensation and which use, as catalyst, an iridium complex corresponding to the following formula (I′):
IrX(L)(L′)₂
in which:
Ir is an iridium atom of valency I or III,
X represents a one-electron ligand, preferably chosen from the group consisting of halogens, hydrogen, an acetate, a substituted or unsubstituted aromatic or heteroaromatic group, CN, RO, RS, R₂N or R₂P with R corresponding to an alkyl, aryl or arylalkyl unit,
L and L′ independently represent a two-electron ligand, preferably chosen from the group consisting of:
   hydrocarbon radicals comprising at least one unit: 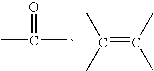
   the radicals:
   —PR′₃, —P(OR′)₃, R′₂O, R′₂S, R′₃N and ═CR′₂ with R′ independently representing a substituted or unsubstituted aromatic or heteroaromatic group or alternatively an alkyl, aryl or aryl-alkyl radical,
   CₙHₙ₊₁— (with n a positive natural integer), preferably corresponding to C₆H₅—.

This patent application PCT/FR02/01340 cites in particular Vaska's complex IrCl(CO)(triphenyl-phosphine)₂.

The objects set out above, and others, are achieved by the present invention, which relates first of all to a silicone composition which can be crosslinked by dehydrogenative condensation, this composition comprising:
-A- at least one organosiloxane monomer, oligomer and/or polymer having, per molecule, at least one reactive ≡SiH unit;
—B— at least one organosiloxane monomer, oligomer and/or polymer exhibiting, per molecule, at least one reactive ≡SiOH unit;
-C- at least one catalytic complex;
-D- optionally at least one crosslinking inhibitor or retarder;
-E- optionally at least one polyorgano-siloxane (POS) resin;
-F- optionally at least one filler;

characterized in that the catalytic complex -C- is an iridium complex obtained by reacting together:
-C1-, on the one hand, an iridium complex of formula (I):
   (IrΣΣ′₂)ₙ
   in which:
1/ n is 1 or 2 and:
   (a) if n is 1, Σ is a 3-electron radical ligand LX (according to the definition given in the work “Chimie Organométallique” [Organo-metallic Chemistry] by Didier Astruc, published in 2000 by EDP sciences, cf. in particular Chapter 1, “Les complexes mono-métalliques” [Monometallic Complexes], pages 31 et seq.), in particular a ligand derived from acetylacetone, from a β-keto ester, from a malonic ester, from an allyl compound, from a carbamate, from a dithio-carbamate or from a carboxylic acid, more particularly a derivative of acetylacetone or of an allyl compound; mention may in particular be made of the acetylacetonato, allyl, cyclopropenyl, carboxylato, carbamato or dithiocarbamato ligands, more particularly the acetylacetonato and allyl ligands, preferably the acetylacetonato ligand;
   (b) if n is 2, Σ is of the 1-electron radical ligand X type (according to the definition given in the work Chimie Organométallique referred to above), having a specific behavior in the presence of the iridium atoms; this ligand bridges the 2 iridium atoms and can be regarded as a 1-electron ligand X for 1 iridium atom and as a 3-electron ligand LX for the combination of the 2 iridium atoms; it can in particular be chosen from halogeno, alkoxy or aryloxy, preferably halogeno, more particularly chloro, or alkoxy;
2/ Σ′, which are identical or different, preferably identical, each represent a 2-electron ligand L (according to the definition given in the work Chimie Organométallique referred to above), for example: donors of a π bond pair, such as olefins, alkynes, C═O double bonds of an aldehyde or of a ketone, C═N or C═S; donors of a σ bond pair, such as H—H (dihydrogen) bonds or H—Si bonds, in particular in silanes (H—SiR₃); or ligands chosen from the following group: organophosphorus compounds, R₂O, R₂S, NR₃ and THF; the organophosphorus ligands are in particular of P(OR)ₚ(R)_{q} type with p and q ranging from 0 to 3, it being known that p+q=3, preferably phosphines PR₃ and phosphites P(OR)₃ (the R groups are as defined later under —C2-;

the preferred ligands Σ′ are hydrocarbon groups comprising at least one unit 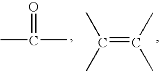
those of the latter type being the more preferred, such as, for example, cyclooctene;

it may be specified that the hydrocarbon groups can be linear, branched, aromatic or (poly)cyclic, can be optionally interrupted by one or more heteroatoms (e.g., O, S or N) and can comprise from 2 to 18 carbon atoms; they can be ligands comprising two of these units (preferably identical units) capable of bonding to the iridium atom (in this case, the two functionalities Σ′ are preferably provided by one and the same molecule connected to the iridium via its two electron-donating functional groups), for example a cyclic compound exhibiting two double bonds, e.g. 1,5-cyclooctadiene, or a diene exhibiting distant double bonds (“distant diene”). Thus, 1,5-cyclo-octadiene is a preferred form;
—C2-, on the other hand, a ligand Σ_{d} chosen from R₂S, R₂O, NR₃, carbenes (see, for example, W. A. Herrmann, Angew. Chem. Int. Ed. Engl., 2002, 41, 1290-1309) or organophosphorus compounds, in particular of formula P(OR)ₚ(R)_{q} with p and q ranging from 0 to 3, it being known that p+q=3, preferably phosphines PR₃ and phosphites P(OR)₃; in which formulae the R radicals, which are identical or different, are linear or branched alkyl radicals having in particular from 1 to 30 carbon atoms, preferably from 1 to 12 carbon atoms; alkyl radicals comprising one or more rings, in particular 1 or 2 rings, it being possible for a ring to have in particular from 4 to 14 carbon atoms, preferably from 5 to 8 carbon atoms; or aryl or aralkyl radicals comprising one or more fused or nonfused aromatic or heteroaromatic rings, in particular 1 or 2 rings, it being possible for a ring to comprise from 4 to 14 carbon atoms, preferably from 5 to 8 carbon atoms; the rings can optionally be substituted by one or more groups, in particular from 1 to 2 groups, such as alkoxy, halide, amino or linear or branched alkyl having in particular from 1 to 12 carbon atoms, preferably from 4 to 12 carbon atoms; a phenyl radical, optionally substituted as indicated above, may in particular be concerned.

According to a preferred embodiment, the iridium complex is a dimeric complex (n=2) of following formula (I′):

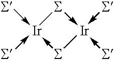

in which Σ and Σ′ have the meanings given above, with the preferences indicated above with regard to the formula (I).

According to a specific embodiment, the catalytic complex —C— is obtained by reaction between:
on the one hand, C1a/ a dimeric complex of formula (I′) in which:
   Σ is a 1-electron radical ligand X chosen from halo, alkoxy or aryloxy, preferably halo, more particularly chloro, or alkoxy;
   Σ′ are 2-electron ligands L formed of hydrocarbon groups comprising at least one unit 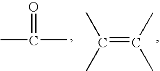
   preferably of hydrocarbon groups comprising the second unit, more preferably with the two Σ′ ligands carried by the same Ir atom being carried by the same molecule, e.g. 1,5-cyclooctadiene,
and, on the other hand, C2a/ a ligand Σ_{d} chosen from R₂S, R₂O, NR₃, carbenes and more particularly organo-phosphorus compounds, in particular of formula P(OR)ₚ(R)_{q} with p and q ranging from 0 to 3, it being known that p+q=3, preferably phosphines PR₃ and phosphites P(OR)₃, with R as defined above, in particular R representing identical or different, preferably identical, aryl or aralkyl groups comprising one or more fused or nonfused aromatic or hetero-aromatic rings, in particular 1 or 2 rings, it being possible for a ring to comprise from 4 to 14 carbon atoms, preferably from 5 to 8 carbon atoms, e.g. phenyl. This or these rings can be substituted by one or more groups, such as alkoxy, halide, amino and linear or branched alkyl, as seen above.

According to a preferred embodiment, the dimeric iridium complex (I′) is bis(1,5-cyclooctadiene)di-iridium(I) dichloride of formula [IrCl(cycloocta-diene)]₂. It is a commercial product.

According to a preferred embodiment, the ligand Σ_{d} is triphenylphosphine (TPP). By way of example, mention may also be made of tris(para-methoxyphenyl)phosphine.

According to a preferred embodiment, the catalytic complex —C— is the product of the mixing of bis(1,5-cyclooctadiene)diiridium(I) dichloride and of TPP.

As indicated below, the catalytic complex —C— is preferably obtained by reacting the abovementioned entities at ambient temperature, e.g. in the vicinity of 25° C., and in the open air, optionally in the presence of a solvent which makes it possible, if necessary, to dissolve the reactive entities. It is clearly understood that different reaction conditions can be applied in an equivalent way so as to obtain a conforming catalytic complex.

The use of such a catalytic complex —C— makes it possible to efficiently catalyze the dehydrogenative condensation reaction between ≡SiH and ≡SiOH siloxane entities under mild temperature conditions, generally at temperatures of less than 150° C., in particular of less than 100° C., and optionally at ambient temperature. Silicone networks or polymers are thus obtained in a few minutes, with variable ≡SiH/≡SiOH ratios.

The catalytic complexes carefully selected in accordance with the invention are effective and economic, in particular with regard to platinum-based catalysts.

It is very simple to test various iridium complex/ligand Σ_{d} pairs and to observe their properties and behavior. As is illustrated in the examples part, the preparation of the catalytic complex does not require a complex process or critical operating conditions. It is sufficient, for example, to prepare a mixture of an iridium complex and of a ligand Σ_{d} to be tested, optionally to dissolve this mixture in a solvent, such as toluene, in the case where the starting entities are in solid form, then to mix the combined product with a silicone composition comprising at least one POS A and one POS B according to the invention and optionally a crosslinking retarder, and to observe the crosslinking time at ambient temperature and/or at a higher temperature, e.g. under temperature conditions similar to the practical application desired. Phosphites and phosphines are, for example, chemical entities which are widely available. It is possible in particular to test combinations of ligands Σ_{d} and of iridium complexes which are commercially available, such as phosphites and phosphines and bis(1,5-cyclooctadiene)diiridium dichloride and (1,5-cyclooctadiene)(acetylacetonato)iridium. The incorporation, in the preparation of the silicone composition, of a simple stage for the preparation of the catalytic complex thus exhibits very obvious advantages, including the possibility of having available varied catalytic complexes suited to the circumstances (e.g., suited to the crosslinking duration and temperature conditions).

These catalytic complexes are in particular advantageous in preparing the elastomeric silicone networks under mild and economical conditions. The applications targeted in this case relate in particular to the adhesion resistance of paper, where it is desired to replace the current systems by less expensive systems, and silicone foams, where it is desired to control the evolution of hydrogen and the quality of the network. For the first application, it is preferable to control the diffusion of the hydrogen in order to prevent the formation of bubbles. For the second application, it is necessary to manage the size of the bubbles in order to optimize the properties of the final foam. These results are all the more significant as the reactivity of siloxane entities, in particular in forming nonlinear (crosslinked) products, is not very high if it is compared with that of hydrosilanes and alcohols in dehydrogenative condensation.

Quantitatively, use is made of 1 ppm to 1000 ppm, in particular of 1 ppm to 300 ppm, of iridium metal with respect to the body composed of the mixture of the oils possessing ≡SiH and ≡SiOH. When the present patent application deals with ranges, the limits are included.

The catalytic complex employs in particular from 0.5 to 10, especially from 0.5 to 5, more particularly from 0.5 to 2, mol of ligand Σ_{d} per 1 mol of Ir. Depending on the preferred embodiment of the invention, use is made of 0.75 to 1.5, in particular of 0.75 to 1.25 and better still of 1 mol of ligand Σ_{d} per 1 mol of Ir.

The siloxane entity -A- comprising reactive ≡SiH units is preferably chosen from the entities which have at least one unit of formula (II) and which are terminated by units of formula (III) or from the cyclic entities (generally comprising from 3 to 12 Si atoms) composed of units of formula (II), these formulae being represented below:

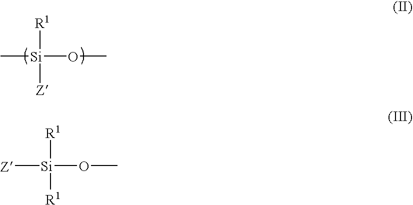

in which:
the symbols R¹ are identical or different and represent:
   a linear or branched alkyl radical comprising from 1 to 8 carbon atoms which is optionally substituted by at least one halogen, preferably fluorine, the alkyl radicals preferably being methyl, ethyl, propyl, octyl and 3,3,3-trifluoropropyl,
   an optionally substituted cycloalkyl radical comprising between 5 and 8 cyclic carbon atoms,
   an optionally substituted aryl radical comprising between 6 and 12 carbon atoms,
   an aralkyl radical having an alkyl part comprising between 5 and 14 carbon atoms and an aryl part comprising between 6 and 12 carbon atoms which is optionally substituted on the aryl part by halogens, alkyls and/or alkoxyls comprising from 1 to 3 carbon atoms,
the symbols Z are alike or different and represent:
   H,
   a group corresponding to the same definition as that given above for R¹,
with, per molecule, at least one of the symbols Z representing H.

As regards the siloxane entities —B— comprising reactive ≡SiOH units, the selection is made in particular in the context of the invention of those which have at least one unit of formula (IV) and which are terminated by units of formula (V) or of cyclic entities (generally comprising from 3 to 12 Si atoms) which are composed of units of formula (IV), these formulae being represented below:

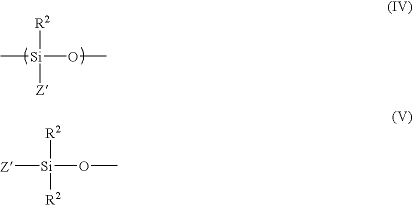

in which:
the symbols R² are identical or different and represent:
   a linear or branched alkyl radical comprising from 1 to 8 carbon atoms which is optionally substituted by at least one halogen, preferably fluorine, the alkyl radicals preferably being methyl, ethyl, propyl, octyl and 3,3,3-trifluoropropyl,
   an optionally substituted cycloalkyl radical comprising between 5 and 8 cyclic carbon atoms,
   an optionally substituted aryl radical comprising between 6 and 12 carbon atoms,
   an aralkyl radical having an alkyl part comprising between 5 and 14 carbon atoms and an aryl part comprising between 6 and 12 carbon atoms which is optionally substituted on the aryl part by halogens, alkyls and/or alkoxyls comprising from 1 to 3 carbon atoms,
the symbols Z′ are alike or different and represent:
   a hydroxyl group,
   a group corresponding to the same definition as that given above for R²,
with, per molecule, at least one of the symbols Z′ representing OH.

The entities of -A- and —B— type can also include, in their structure, “Q” or “T” units defined as indicated below: 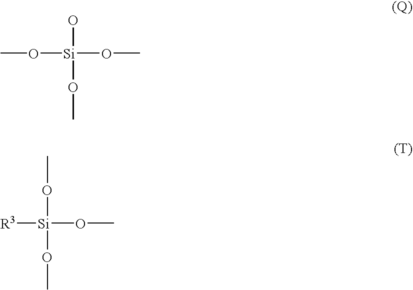
with it being possible for R³ to represent one of the substituents provided for R¹ or R².

According to an advantageous embodiment of the invention, the polyorganosiloxanes -A- used comprise from 1 to 50 SiH units per molecule.

According to an advantageous embodiment of the invention, the polyorganosiloxanes —B— used comprise from 1 to 50 SiOH units per molecule.

According to a preferred embodiment, the poly-organosiloxanes -A- correspond to the general formula (VI):

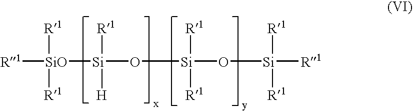

in which:
x and y each represent an integer or fractional number varying between 0 and 200,
R′¹ and R″¹ represent, independently of one another:
   a linear or branched alkyl radical comprising from 1 to 8 carbon atoms which is optionally substituted by at least one halogen, preferably fluorine, the alkyl radicals preferably being methyl, ethyl, propyl, octyl and 3,3,3-trifluoropropyl,
   an optionally substituted cycloalkyl radical comprising between 5 and 8 cyclic carbon atoms,
   an optionally substituted aryl radical comprising between 6 and 12 carbon atoms,
   an aralkyl radical having an alkyl part comprising between 5 and 14 carbon atoms and an aryl part comprising between 6 and 12 carbon atoms which is optionally substituted on the aryl part,
it being possible for R″¹ also to correspond to hydrogen, with the condition according to which at least one of the R″¹ radicals (preferably both) correspond to hydrogen when x=0.

According to a preferred embodiment, the poly-organosiloxanes —B— correspond to the general formula (VII):

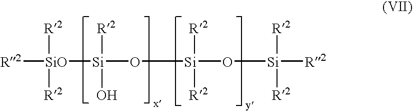

in which:
x′ and y′ each represent an integer or fractional number varying between 0 and 1200,
R′² and R″² represent, independently of one another:
   a linear or branched alkyl radical comprising from 1 to 8 carbon atoms which is optionally substituted by at least one halogen, preferably fluorine, the alkyl radicals preferably being methyl, ethyl, propyl, octyl and 3,3,3-trifluoropropyl,
   an optionally substituted cycloalkyl radical comprising between 5 and 8 cyclic carbon atoms,
   an optionally substituted aryl radical comprising between 6 and 12 carbon atoms,
   an aralkyl radical having an alkyl part comprising between 5 and 14 carbon atoms and an aryl part comprising between 6 and 12 carbon atoms which is optionally substituted,
it being possible for R″² also to correspond to OH, with the condition according to which at least one of the R″² radicals (preferably both) correspond to OH when x′=0.

The following compounds: 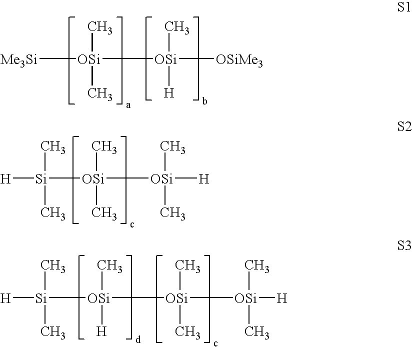
with a, b, c, d and e representing a number varying from:

in the polymer of formula S1:
0≦a≦150, preferably 0≦a≦100, preferably 0≦a≦20, and
1≦b≦55, preferably 10≦b≦55, preferably 30≦b≦55,

in the polymer of formula S2:
0≦c≦15,

in the polymer of formula S3:
5≦d≦200, preferably 20≦d≦50, and
2≦e≦50, preferably 10≦e≦30,
   are very particularly suitable in the invention as polyorganosiloxanes -A-.

The compounds of formula:

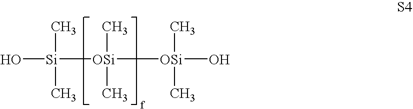

with 1≦f≦1200, preferably 50≦f≦400 and more preferably still 150≦f≦250,

are very particularly suitable in the invention as polyorganosiloxanes —B—.

Provided that the siloxane entities -A- and —B— are oligomers or polymers, they can be described as indicated below.

The POS -A- can be linear (e.g. (VI)), branched or cyclic. For economic reasons, its viscosity is preferably less than 100 mPa·s at 25° C.; the identical or different organic radicals are preferably methyl, ethyl and/or phenyl. When the POS is linear, the hydrogen atoms of the ≡SiH functional groups are bonded directly to the silicon atoms situated at the chain end(s) and/or in the chain.

Mention may be made, as example of linear constituent -A-, of polymethylhydrosiloxanes comprising trimethylsiloxyl and/or hydrodimethylsiloxy ends.

Mention may be made, among cyclic polymers, of those corresponding to the following formulae:

[OSi(CH₃)H]₄; [OSi(CH₃)H]₅; [OSi(CH₃)H]₃; [OSi(CH₃)H]₈; [OSi(C₂H₅)H]₃.

Mention may be made, as concrete examples of branched polymers, of:
CH₃Si[CH₃)₃][OSi(CH₃)₂H]₂; Si[OSi(CH₃)(C₂H₅)H][OSi(CH₃)₂H]₃ and those composed of SiOH₂ units and H(CH₃)₂SiO_{0.5} units with a CH₃Si ratio of 1 to 1.5.

The constituent —B— can exhibit a viscosity which can reach 200 000 mPa·s. For economic reasons, a constituent having a viscosity generally of the order of 20 to 10 000 mPa·s is chosen.

The identical or different organic groups generally present in the α,ω-hydroxylated oils or gums are the methyl, ethyl, phenyl or trifluoropropyl radicals. Preferably, at least 80% by number of said organic groups are methyl groups bonded directly to the silicon atoms. In the context of the present invention, preference is given more especially to α,ω-bis(hydroxy)polydimethylsiloxanes.

The —B— entities can comprise resins possessing silanol functional groups exhibiting, per molecule, at least one of the R′SiO_{0.5} unit (M unit) and R′²SiO unit (D unit), in combination with at least one of the R′SiO_{0.5} unit (T unit) and SiO₂ unit (Q unit). The R′ radicals generally present are methyl, ethyl, isopropyl, tert-butyl and n-hexyl. Mention may be made, as examples of resins, of the resins MQ(OH), MDQ(OH), TD(OH) and MDT(OH).

It is possible to employ solvents for the POS -A- or —B—, so as to adjust the viscosity of the composition. Mention may be made, as examples of such conventional solvents for silicone polymers, of solvents of aromatic type, such as xylene and toluene, saturated aliphatic solvents, such as hexane, heptane, White Spirit®, tetrahydrofuran and diethyl ether, or chlorinated solvents, such as methylene chloride and perchloroethylene. In the context of the present invention, it will be preferable, however, not to use a solvent.

The respective amounts of siloxane entities -A- and —B— are also determining in order to be able to satisfactorily carry out the dehydrogenative condensation of the composition according to the invention.

Thus, the ≡SiH/≡SiOH ratio is advantageously between 1 and 100, preferably between 2 and 50 and more preferably still between 2 and 25.

The composition according to the invention can also comprise at least one crosslinking inhibitor or retarder -D-. Such a constituent is generally used to confer a degree of pot life on the ready-for-use composition. By varying, on the one hand, the nature of the catalytic combination and its concentration in the composition (which results in a given crosslinking rate) and, on the other hand, the nature of the retarder and its concentration, it is possible to adjust the pot life. The activity of the catalytic combination is restored by heating (thermal activation). The retarder is preferably chosen from acetylenic alcohols (ethynylcyclohexanol: ECH) and/or diallyl maleates and/or triallyl isocyanurates and/or dialkyl maleates (diethyl maleates) and/or dialkyl alkynedicarboxylates (diethyl acetylenedicarboxylate) or alternatively from polyorganosiloxanes, advantageously cyclic and substituted by at least one alkenyl, tetramethylvinylcyclotetrasiloxane being particularly preferred, or alkylated maleates.

Acetylenic alcohols (see, for example, FR-B-1 528 464 and FR-A-2 372 874) are the preferred retarders. They are in particular those corresponding to the following formula:
R¹—(R²)C(OH)—C≡CH
in which:
R¹ is a linear or branched alkyl radical or a phenyl radical;
R² is H or a linear or branched alkyl radical or a phenyl radical;
   it being possible for the R¹ and R² radicals and the carbon atom situated in the alpha position with respect to the triple bond optionally to form a ring;
   the total number of carbon atoms present in R¹ and R² being at least 5, preferably from 9 to 20.

Said alcohols are preferably chosen from those exhibiting a boiling point of greater than 250° C. Mention may be made, as examples, of:
1-ethynylcyclohexan-1-ol;
3-methyldodec-1-yn-3-ol;
3,7,11-trimethyldodec-1-yn-3-ol;
1,1-diphenylprop-2-yn-1-ol;
3-ethyl-6-ethylnon-1-yn-3-ol;
3-methylpentadec-1-yn-3-ol.

These α-acetylenic alcohols are commercial products.

Such a retarder is present in particular in a proportion of 3000 ppm at most, preferably in a proportion of 100 to 2000 ppm, with respect to the total weight-of the compounds -A- and —B—.

The composition according to the invention can also comprise one or more POS resins -E-. These resins are well known branched POS oligomers or polymers which are commercially available. They are present in the form of solutions, preferably siloxane solutions. They exhibit, in their structure, at least two different units chosen from those of formula R*₃SiO_{0.5} (M unit), R*₂SiO (D unit), R*SiO_{1.5} (T unit) and SiO₂ (Q unit), at least one of these units being a T or Q unit.

The R* radicals are identical or different and are chosen from linear or branched C₁-C₆ alkyl radicals, C₂-C₄ alkenyl radicals, the phenyl radical or the 3,3,3-trifluoropropyl radical. Mention may be made, for example, as R* alkyl radicals, of the methyl, ethyl, isopropyl, tert-butyl and n-hexyl radicals and, as R* alkenyl radicals, of the vinyl radical. It should be understood that, in the POS resins -E- of the abovementioned type, for a portion of them, the R* radicals are alkenyl radicals.

Mention may be made, as examples of branched organopolysiloxane oligomers or polymers -E-, of MQ resins, MDQ resins, TD resins and MDT resins, it being possible for the alkenyl functional groups to be carried by the M, D and/or T units. Mention may be made, as examples of resins -E- which are particularly well suited, of the vinylated MDQ or MQ resins having a content by weight of vinyl groups of between 0.2 and 10% by weight, these vinyl groups being carried by the M and/or D units.

This structuring resin -E- is advantageously present in a concentration of between 10 and 70% by weight with respect to the combined constituents of the composition, preferably between 30 and 60% by weight and more preferably still between 40 and 60% by weight.

The composition according to the invention can also comprise a filler —F—, preferably an inorganic filler, chosen from siliceous or nonsiliceous materials.

When siliceous materials are concerned, they can act as reinforcing or semi-reinforcing filler. The reinforcing siliceous fillers are preferably chosen from colloidal silicas, fumed and precipitated silica powders, or their mixtures. Semi-reinforcing siliceous fillers, such as diatomaceous earths or ground quartz, can also be employed. These powders exhibit a main particle size generally of less than 0.1 μm and a specific surface BET of greater than 50 m²/g, preferably between 100 and 300 m²/g.

As regards nonsiliceous organic materials, they can be involved as semi-reinforcing or bulking inorganic filler. Examples of these nonsiliceous fillers, which can be used alone or as a mixture, are carbon black, titanium dioxide, aluminum oxide, alumina hydrate, expanded vermiculite, zirconia, a zirconate, unexpanded vermiculite, calcium carbonate, zinc oxide, mica, talc, iron oxide, barium sulfate and slaked lime. These fillers have a particle size generally of between 0.001 and 300 μm and a BET specific surface of less than 100 m²/g.

In practice but without implied limitation, the filler employed is a silica.

The filler can be treated using any appropriate compatibilizing agent and in particular hexamethyldi-silazane. For further details in this regard, reference may be made, for example, to patent FR-B-2 764 894.

With regard to the weight, it is preferable to employ an amount of filler of between 5 and 30%, preferably between 7 and 20%, by weight, with respect to the combined constituents of the preparation.

Naturally, the composition can be enriched using all kinds of additives, depending upon the final applications targeted.

In the adhesion resistance application on flexible supports (paper or polymer film), the composition can comprise an adhesion adjusting system selected from known systems. Those disclosed in French patent FR-B-2 450 642, patent U.S. Pat. No. 3,772,247 or European patent application EP-A-0 601 938 may be concerned. Mention may be made, as examples, of the adjusting systems based:
on 96 to 85 parts by weight of at least one reactive polyorganosiloxane resin (A) of type: MD^{Vi}Q, MM^{Vi}Q, MD^{Vi}T, MM^{hexenyl}Q or MM^{allyloxypropyl}Q,
on 4 to 15 parts by weight of at least one unreactive resin (B) of type: MD′Q, MDD′Q, MDT′, MQ or MDQ.

Other functional additives of this composition can be stabilizing agents, bactericides, photosensitizers, fungicides, corrosion inhibitors, antifreeze agents, wetting agents, antifoaming agents, synthetic latexes, colorants or acidifying agents.

Mention may also be made, among conventional additives, of adhesion promoters, such as, for example, those comprising at least one alkoxylated organosilane, at least one epoxidized organosilicon compound and at least one metal chelate and/or one metal alkoxide, for example VTMO (VinylTriMethoxySilane), GLYMO (GLYcidoxypropyltriMethOxysilane) or TBT (tert-butyl titanate).

This composition can be a solution or an emulsion. In the latter case, it can then comprise at least one surfactant and optionally at least one agent for fixing the pH, such as HCO₃⁻/CO₃²⁻ and/or H₂PO₄⁻/HPO₄²⁻.

Another subject matter of the present invention is the use of a catalytic iridium complex as defined in the present application as dehydrogenative condensation catalyst for a silicone composition which crosslinks by dehydrogenative condensation, this composition being moreover defined in the present application.

A further subject matter of the present invention is the catalytic complexes capable of being obtained in accordance with the invention by reacting at least one iridium complex as defined above and at least one ligand as defined above.

According to yet another of its aspects, the present invention relates to a process for polymerizing and/or crosslinking a composition as defined above. This process is characterized in that a dehydrogenative condensation is carried out between said compounds -A- and —B— and in that said dehydrogenative condensation is initiated by thermal activation of the catalytic complex —C—. The catalytic complex according to the invention can be prepared in a first stage by mixing the abovementioned entities, as described above.

According to another alternative form of the invention, the invention relates to a process for the preparation of a branched polyorganosiloxane comprising at least two polyorganosiloxane chains connected to one another via an Si—O—Si siloxyl group in which a dehydrogenative condensation reaction is carried out between an organosiloxane monomer, oligomer or polymer A′ comprising reactive ≡SiH units and an organosiloxane monomer, oligomer or polymer B′ comprising reactive ≡SiOH units, characterized in that said dehydrogenative condensation reaction is carried out in the presence of the catalytic complex C defined as above or according to one of claims 1 to 15 and is optionally initiated by thermal activation. According to a preferred form, the ≡SiH/≡SiOH ratio is greater than 1.

The catalytic complex can either be added to the mixture of the compounds A and B, for example of the polymers of the S1 or S2 or S3 type with a polymer of the S4 type, or, preferably, be mixed beforehand with the compound B, for example the polymer of the S4 type, before being brought into contact with the compound A, for example the polymer S1 or S2 or S3. Generally, the mixtures are prepared with stirring at ambient temperature.

The catalytic complex can be employed as is or in solution in a solvent.

The catalytic complex solution can, for example, be used to prepare a bath with the monomer(s), oligomer(s) and/or polymer(s) to be polymerized and/or crosslinked by dehydrogenative condensation, so that the concentration of the catalytic complex(es) present is between 0.01 and 5% by weight in said bath and preferably between 0.05 and 0.5%.

The solvents which can be used can in particular be esters, ethers, aromatic solvents, water in the form of traces, carbonates and hindered alcohols. Mention may be made, for the alcohols, of isopropylbenzyl alcohol or benzyl alcohol. Mention may be made, for the ethers, of di(n-butyl) ether. Mention may be made, for the esters, of dibutyl maleate, dimethyl ethylmalonate, methyl salicylate, dioctyl adipate, butyl tartrate, ethyl lactate, n-butyl lactate or isopropyl lactate. Other solvents are toluene and tetrahydrofuran.

The silicone composition according to the invention, which can be used in particular as coating base for the preparation of release coatings possessing a water-repellant nature, is prepared using means and according to mixing methodologies well known to a person skilled in the art, whether compositions, with or without solvents, or emulsions are involved.

The invention also relates to a process for producing at least one release coating on a support, preferably a flexible support, characterized in that it comprises the application, to this support, of a composition as defined above, preferably employing POS -A- and —B— as defined above, and then ensuring that crosslinking occurs.

In accordance with this process, the compositions can be applied using devices used on industrial machines for coating paper, such as a roll coating head, e.g. a five-roll coating head, or air knife or smoothing rod systems, on flexible supports or materials and then cured by moving through appropriate heating devices, such as tunnel ovens heated at 70-200° C.; the passage time in these ovens depends on temperature; it is generally of the order of 5 to 15 seconds at a temperature of the order of 100° C. and of the order of 1.5 to 3 seconds at a temperature of the order of 180° C.

Said compositions can be deposited on any flexible material or substrate, such as paper of various types (e.g., supercalendered, coated or glassine), board, cellulose sheets, metal sheets or plastic films (polyester, polyethylene, polypropylene, and the like).

The amounts of compositions deposited can be of the order of 0.5 to 2 g per m² of surface to be treated, which corresponds to the deposition of layers of the order of 0.5 to 2 μm.

The materials or supports thus coated can subsequently be brought into contact with any adhesive material, e.g. rubber, acrylic or other, which is sensitive to pressure. The adhesive material is then easily detachable from said support or material.

The flexible supports coated with a release silicone film can, for example, be:
an adhesive tape, the internal face of which is coated with a layer of pressure-sensitive adhesive and the external face of which comprises the release silicone coating;
or a paper or a polymer film for protecting the adhesive face of a self-adhesive or pressure-sensitive adhesive element;
or a polymer film of the poly(vinyl chloride) (PVC), polypropylene, polyethylene or poly(ethylene terephthalate) type.

Another subject matter of the invention is a process for producing at least one article made of crosslinked silicone foam, characterized in that it comprises the stage of crosslinking a composition as defined above, while preferably employing the POS A and POS B as defined above, while ensuring that at least a portion of the hydrogen gas formed is not discharged from the reaction medium.

The compositions according to the invention are of use in the field of release coatings on paints, the encapsulation of electrical and electronic components, or coatings for textiles, and in the field of the sheathing of optical fibers.

Another subject matter of the invention is any coating obtained by crosslinking a composition comprising siloxane entities -A- possessing reactive SiH units, e.g. of S1, S2 or S3 type, as are defined above, and siloxane entities —B—, e.g. of S4 type, as are defined above. These coatings can be of varnish, adhesive coating, release coating and/or ink type.

The invention is also targeted at:
any article composed of a solid material, at least one surface of which is coated with the composition targeted above which is thermally polymerized and/or crosslinked;
and the crosslinked silicone foam, in particular a foam obtained by crosslinking a composition comprising the entities S1 and/or S2 and/or S3 as components -A- and the entity of S4 type as components —B—, with production of hydrogen gas by dehydrogenative condensation.

Another subject matter of the present invention is the resins or polymers capable of being obtained from the compositions described above.

The invention will now be described in more detail using nonlimiting implementational examples.

### EXAMPLES

### Examples 1 to 10 and Counter Example 1

### General Procedure for Examples 1 to 10

A mixture of silicone oils is prepared from the following reactive oils:
a polymethylhydrosiloxane oil comprising 1600 meq. SiH/100 g and having a viscosity of 30 mPa·s, hereinafter SiH oil,
an α,ω-dihydroxylated polydimethylsiloxane oil comprising 14meq. SiOH/100 g and having a viscosity of 750 mPa·s, hereinafter SiOH oil.

Furthermore, the desired amounts of iridium complex (IrClCod]₂ and of ligand Σ_{d} are weighed out in a 30 ml flask equipped with a magnetic stirrer and are then diluted with a small amount of sulfur-free toluene (0.5 ml). The necessary amount of the preformed mixture of silicone oils is added to this solution. The time measurements begin at this point, at the same time as the magnetic stirring begins.

After stirring at ambient temperature, the setting (crosslinking) time is measured. The conditions and the results are combined in table 1.

### General Procedure for Counter Example 1

A mixture of silicone oils is prepared from the following reactive oils:
a polymethylhydrosiloxane oil comprising 1600 meq. SiH/100 g and having a viscosity of 30 mPa·s, hereinafter SiH oil,
an α,ω-dihydroxylated polydimethylsiloxane oil comprising 14 meq. SiOH/100 g and having a viscosity of 750 mPa·s, hereinafter SiOH oil.

Furthermore, the desired amounts of iridium complex [IrClCod]₂ are weighed out in a 30 ml flask equipped with a magnetic stirrer and are then diluted with a small amount of sulfur-free toluene (0.5 ml). After stirring for 10 minutes, the necessary amount of the preformed mixture of silicone oils is added to this solution. The time measurements begin at this point, at the same time as the magnetic stirring begins.

After stirring at ambient temperature, the setting (crosslinking) time is measured.

The conditions and the result are combined in table 1.

TABLE 1
RESULTS

| | | | | | | | | | Cross- |
|---|---|---|---|---|---|---|---|---|---|
| | | | | SiOH | SiH | Molar ratio | | | linking |
| | [IrClCod]₂ | Ligand Σ_{d} | | oil | oil | | SiH/ | Ir/ | Ambient |
| | (mg) | Nature | (mg) | (g) | (g) | Σ_{d}/Ir | SiOH | SiOH | temp. |
| Counter | 2.2 | — | 0 | 11.1 | 0.19 | — | 2 | 4.2 × 10⁻³ | NC* |
| ex. 1 | | | | | | | | | |
| ex. 1 | 4.7 | 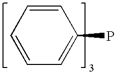 | 3.8 | 23.5 | 0.4 | 1 | 2 | 4.2 × 10⁻³ | 2 min |
| ex. 2 | 3.5 | 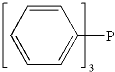 | 5.6 | 17.5 | 0.3 | 2 | 2 | 4.2 × 10⁻³ | 1 h |
| ex. 3 | 5 | 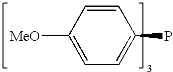 | 4.3 | 25 | 0.43 | 1 | 2 | 4.2 × 10⁻³ | 2 min |
| ex. 4 | 4.8 | 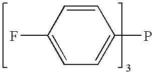 | 4.3 | 24 | 0.41 | 1 | 2 | 4.2 × 10⁻³ | 2 min |
| ex. 5 | 3.9 | 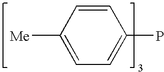 | 3.5 | 19.5 | 0.34 | 1 | 2 | 4.2 × 10⁻³ | 4 min |
| ex. 6 | 3.4 | 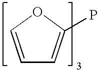 | 2.5 | 17 | 0.29 | 1.1 | 2 | 4.2 × 10⁻³ | 7 min |
| ex. 7 | 3.5 | 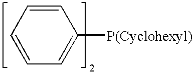 | 2.7 | 17.5 | 0.3 | 1 | 2 | 4.2 × 10⁻³ | 7 min |
| ex. 8 | 4 | 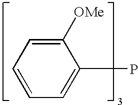 | 4.0 | 20 | 0.34 | 1 | 2 | 4.2 × 10⁻³ | 12 min |
| ex. 9 | 3.5 | 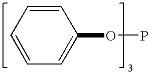 | 3.0 | 17.5 | 0.3 | 1 | 2 | 4.2 × 10⁻³ | 18 min |
| ex. 10 | 3.5 | 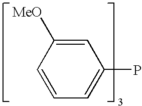 | 3.5 | 17.5 | 0.3 | 1 | 2 | 4.2 × 10⁻³ | 3 min |

*NC: No crosslinking after stirring at a.t. for 6 h

It should be clearly understood that the invention defined by the appended claims is not limited to the specific embodiments indicated in the description above but encompasses the alternative forms thereof which depart neither from the scope nor from the spirit of the present invention.

What is claimed is:

1. A silicone composition which can be crosslinked by dehydrogenative condensation, this composition comprising:
-A- at least one organosiloxane monomer, oligomer and/or polymer having, per molecule, at least one reactive ≡SiH unit;
—B— at least one organosiloxane monomer, oligomer and/or polymer exhibiting, per molecule, at least one reactive ≡SiOH unit;
—C— at least one catalytic complex;
-D- optionally at least one crosslinking inhibitor or retarder;
-E- optionally at least one polyorgano-siloxane (POS) resin;
—F— optionally at least one filler;
characterized in that the catalytic complex —C— is an iridium complex capable of being obtained by reacting together:
—C1-, on the one hand, an iridium complex of formula (I):
(IrΣΣ′₂)₂
in which:
1/ n is 1 or 2 and:
if n is 1, Σ is a 3-electron radical ligand LX, preferably a ligand derived from acetylacetone, from a β-keto ester, from a malonic ester, from an allyl compound, from a carbamate, from a dithiocarbamate or from a carboxylic acid;
if n is 2, Σ is a 1-electron radical ligand X which bridges the 2 iridium atoms, having a function of 1-electron ligand X for 1 iridium atom and of 3-electron ligand LX for the combination of the 2 iridium atoms, in particular a ligand chosen from halo, alkoxy or aryloxy;
2/ Σ′, which are identical or different, each represent a 2-electron ligand L chosen in particular from: donors of a π bond pair, such as olefins, alkynes, C═O double bonds of an aldehyde or of a ketone, C═N or C═S; donors of a σ bond pair, such as H—H (dihydrogen) bonds or H—Si bonds, in particular in silanes (H—SiR₃); and organophosphorus, R₂O, R₂S, NR₃ or THF ligands;
—C2-, on the other hand, a ligand Σ_{d} chosen from R₂S, R₂O, NR₃, carbenes or organophosphorus compounds of formula P(OR)ₚ(R)_{q} with p and q ranging from 0 to 3, it being known that p+q=3.

2. The composition as claimed in claim 1, characterized in that n=2 and the iridium complex is a dimeric complex of following formula (I′): 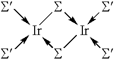
in which:
Σ is a 1-electron radical ligand X which bridges the 2 iridium atoms, having a function of 1-electron ligand X for 1 iridium atom and of 3-electron ligand LX for the combination of the 2 iridium atoms, in particular a ligand chosen from halo, alkoxy or aryloxy,
Σ′ are 2-electron ligands L formed of hydrocarbon groups comprising at least one unit 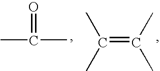
preferably of hydrocarbon groups comprising the second unit, more preferably with the two Σ′ ligands carried by the same Ir atom being carried by the same molecule.

3. The composition as claimed in claim 1, characterized in that n is 1 and Σ is chosen from the acetylacetonato, allyl, cyclopropenyl, carboxylato, carbamato or dithiocarbamato ligands, more particularly the acetylacetonato and allyl ligands, preferably the acetylacetonato ligand.

4. The composition as claimed in claim 1 or 2, characterized in that n is 2 and Σ is a ligand chosen from halo, more particularly chloro, and alkoxy.

5. The composition as claimed in one of claims 1 to 4, characterized in that the Σ′ ligands, which are identical or different, preferably identical, each represent a 2-electron ligand L chosen from hydrocarbon groups comprising at least one unit 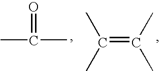
the hydrocarbon groups being linear, branched, aromatic or (poly)cyclic, optionally interrupted by one or more heteroatoms (e.g., O, S or N) and comprising from 2 to 18 carbon atoms.

6. The composition as claimed in claim 5, characterized in that the two Σ′ ligands bonded to the same Ir atom are functionalities carried by the same molecule.

7. The composition as claimed in claim 6, characterized in that this molecule is 1,5-cycloocta-diene.

8. The composition as claimed in one of claims 1 to 4, characterized in that the Σ′ ligands are of P(OR)ₚ(R)_{q} type with p and q ranging from 0 to 3, it being known that p+q=3, preferably phosphines PR₃ and phosphites P(OR)₃.

9. The composition as claimed in one of the preceding claims, characterized in that the ligand Σ_{d} is an organophosphorus compound of formula P(OR)ₚ(R)_{q} with p and q ranging from 0 to 3, it being known that p+q=3, preferably a phosphine PR₃ or a phosphite P(OR)₃; in which formulae the R radicals, which are identical or different, are linear or branched alkyl radicals having in particular from 1 to 30 carbon atoms, preferably from 1 to 12 carbon atoms; alkyl radicals comprising one or more rings, in particular 1 or 2 rings, it being possible for a ring to have in particular from 4 to 14 carbon atoms, preferably from 5 to 8 carbon atoms; or aryl or aralkyl radicals comprising one or more fused or nonfused aromatic or heteroaromatic rings, in particular 1 or 2 rings, it being possible for a ring to comprise from 4 to 14 carbon atoms, preferably from 5 to 8 carbon atoms; the ring or rings are optionally substituted by one or more groups, in particular from 1 to 2 groups, such as alkoxy, halide, amino or linear or branched alkyl having in particular from 1 to 12 carbon atoms, preferably from 4 to 12 carbon atoms.

10. The composition as claimed in one of claims 1-2 and 4-9, characterized in that n=2 and the dimeric iridium complex is bis(1,5-cyclooctadiene)di-iridium(I) dichloride.

11. The composition as claimed in one of claims 1 to 10, characterized in that the ligand Σ_{d} is chosen from the group consisting of triphenylphosphine and tris(para-methoxyphenyl)phosphine.

12. The composition as claimed in claim 1, characterized in that the catalytic complex —C— is the product of the mixing of bis(1,5-cyclooctadiene)di-iridium(I) dichloride and of triphenylphosphine.

13. The composition as claimed in any one of the preceding claims, characterized in that it comprises from 1 ppm to 1000 ppm, preferably from 1 ppm to 300 ppm, of iridium metal with respect to the body composed of the mixture of the oils possessing ≡SiH and ≡SiOH.

14. The composition as claimed in any one of the preceding claims, characterized in that the catalytic complex employs from 0.5 to 10, especially from 0.5 to 5, more particularly from 0.5 to 2, mol of ligand Σ_{d} per 1 mol of Ir.

15. The composition as claimed in claim 14, characterized in that the catalytic complex employs from 0.75 to 1.5, in particular from 0.75 to 1.25 and better still 1 mol of ligand Σ_{d} per 1 mol of Ir.

16. The composition as claimed in any one of the preceding claims, characterized in that the organo-siloxane monomers, oligomers and/or polymers -A- possessing reactive ≡SiH units have at least one unit of formula (II) and are terminated by units of formula (III) or are cyclic and are composed of units of formula (II) represented below: 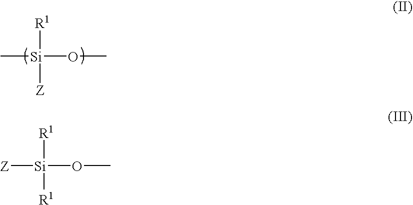
in which:
the symbols R¹ are identical or different and represent:
a linear or branched alkyl radical comprising from 1 to 8 carbon atoms which is optionally substituted by at least one halogen, preferably fluorine, the alkyl radicals preferably being methyl, ethyl, propyl, octyl and 3,3,3-trifluoropropyl,
an optionally substituted cycloalkyl radical comprising between 5 and 8 cyclic carbon atoms,
an optionally substituted aryl radical comprising between 6 and 12 carbon atoms,
an aralkyl radical having an alkyl part comprising between 5 and 14 carbon atoms and an aryl part comprising between 6 and 12 carbon atoms which is optionally substituted on the aryl part by halogens, alkyls and/or alkoxyls comprising from 1 to 3 carbon atoms,
the symbols Z are alike or different and represent:
a hydrogen radical,
a group corresponding to the same definition as that given above for R¹,
with, per molecule, at least one of the symbols Z representing H.

17. The composition as claimed in one of the preceding claims, characterized in that the organo-siloxane monomers, oligomers and/or polymers —B— possessing reactive ≡SiOH units have at least one unit of formula (IV) and are terminated by units of formula (V) or are cyclic and are composed of units of formula (IV) represented below: 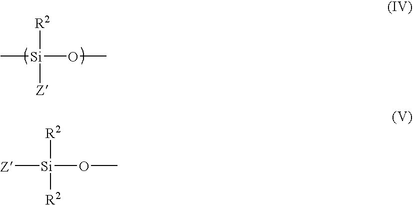
in which:
the symbols R² are identical or different and represent:
a linear or branched alkyl radical comprising from 1 to 8 carbon atoms which is optionally substituted by at least one halogen, preferably fluorine, the alkyl radicals preferably being methyl, ethyl, propyl, octyl and 3,3,3-trifluoropropyl,
an optionally substituted cycloalkyl radical comprising between 5 and 8 cyclic carbon atoms,
an optionally substituted aryl radical comprising between 6 and 12 carbon atoms,
an aralkyl radical having an alkyl part comprising between 5 and 14 carbon atoms and an aryl part comprising between 6 and 12 carbon atoms which is optionally substituted on the aryl part by halogens, alkyls and/or alkoxyls comprising from 1 to 3 carbon atoms,
the symbols Z′ are alike or different and represent:
a hydroxyl group,
a group corresponding to the same definition as that given above for R²,
with, per molecule, at least one of the symbols Z′ representing OH.

18. The composition as claimed in one of the preceding claims, characterized in that the organo-siloxane monomers, oligomers or polymers -A- possessing reactive ≡SiH units correspond to the general formula (VI): 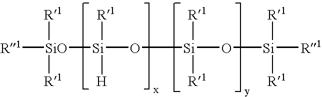
in which:
x and y each represent an integer or fractional number varying between 0 and 200,
R′¹ and R″¹ represent, independently of one another:
a linear or branched alkyl radical comprising from 1 to 8 carbon atoms which is optionally substituted by at least one halogen, preferably fluorine, the alkyl radicals preferably being methyl, ethyl, propyl, octyl and 3,3,3-trifluoropropyl,
an optionally substituted cycloalkyl radical comprising between 5 and 8 cyclic carbon atoms,
an optionally substituted aryl radical comprising between 6 and 12 carbon atoms,
an aralkyl radical having an alkyl part comprising between 5 and 14 carbon atoms and an aryl part comprising between 6 and 12 carbon atoms which is optionally substituted on the aryl part,
it being possible for R″¹ also to correspond to hydrogen, with the condition according to which at least one of the R″¹ radicals (preferably both) correspond to hydrogen when x=0.

19. The composition as claimed in one of the preceding claims, characterized in that the organo-siloxane monomers, oligomers or polymers —B— possessing reactive ≡SiOH units correspond to the general formula (VII): 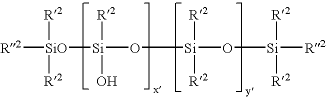
in which:
x′ and y′ each represent an integer or fractional number varying between 0 and 1200,
R′² and R″² represent, independently of one another:
a linear or branched alkyl radical comprising from 1 to 8 carbon atoms which is optionally substituted by at least one halogen, preferably fluorine, the alkyl radicals preferably being methyl, ethyl, propyl, octyl and 3,3,3-trifluoropropyl,
an optionally substituted cycloalkyl radical comprising between 5 and 8 cyclic carbon atoms,
an optionally substituted aryl radical comprising between 6 and 12 carbon atoms,
an aralkyl radical having an alkyl part comprising between 5 and 14 carbon atoms and an aryl part comprising between 6 and 12 carbon atoms which is optionally substituted on the aryl part,
it being possible for R″² also to correspond to OH, with the condition according to which at least one of the R″² radicals (preferably both) correspond to OH when x′=0.

20. The composition as claimed in one of the preceding claims, characterized in that the organo-siloxane monomers, oligomers or polymers possessing reactive ≡SiH units comprise from 1 to 50 active ≡SiH units per molecule.

21. The composition as claimed in one of the preceding claims, characterized in that the organo-siloxane monomers, oligomers or polymers possessing reactive ≡SiOH units comprise from 1 to 50 active ≡SiOH units per molecule.

22. The composition as claimed in one of the preceding claims, characterized in that the organo-siloxane monomers, oligomers or polymers -A- possessing reactive ≡SiH units are chosen from the compounds of formulae: 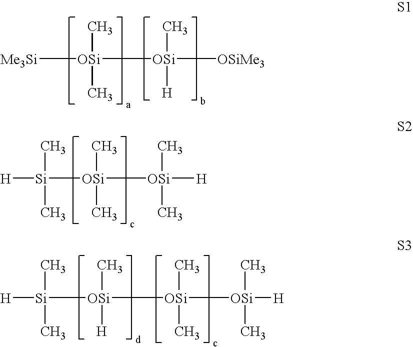
with a, b, c, d and e representing a number varying from:
in the polymer of formula S1:
0≦a≦150, preferably 0≦a≦100, preferably 0≦a≦20, and
1≦b≦55, preferably 10≦b≦55, preferably 30≦b≦55,
in the polymer of formula S2:
0≦c≦15,
in the polymer of formula S3:
5≦d≦200, preferably 20≦d≦50, and
2≦e≦50, preferably 10≦e≦30.

23. The composition as claimed in one of the preceding claims, characterized in that the organo-siloxane monomers, oligomers or polymers —B— possessing reactive ≡SiOH units are chosen from the compounds of formula: 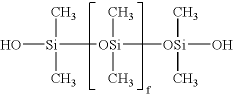
with 1≦f≦1200, preferably 50≦f≦400, preferably 150≦f≦250.

24. The composition as claimed in one of the preceding claims, characterized in that the ≡SiH/≡SiOH ratio is between 1 and 100, preferably between 10 and 50 and more preferably still between 15 and 45.

25. A process for polymerizing and/or crosslinking a composition as claimed in any one of the preceding claims, characterized in that a dehydrogenative condensation is carried out between said compounds -A- and —B— and in that said dehydrogenative condensation is initiated by thermal activation of the catalytic complex —C—.

26. A process for producing at least one release coating on a support, preferably a flexible support, characterized in that it comprises the application, to this support, of a composition as claimed in any one of claims 1 to 24 and then ensuring that crosslinking occurs.

27. A process for producing at least one article made of crosslinked silicone foam, characterized in that it comprises applying, to this support, a composition as claimed in any one of claims 1 to 24 and then ensuring that crosslinking occurs.

28. A coating, obtained by crosslinking a composition as claimed in any one of claims 1 to 24.

29. An article composed of a solid material, at least one surface of which is coated with a coating as claimed in claim 28.

30. A crosslinked silicone foam, obtained by crosslinking a composition as claimed in any one of claims 1 to 24.

31. A process for the preparation of a branched polyorganosiloxane comprising at least two polyorganosiloxane chains connected to one another via an Si—O—Si siloxyl group in which a dehydrogenative condensation reaction is carried out between an organosiloxane monomer, oligomer or polymer A′ comprising reactive ≡SiH units and an organosiloxane monomer, oligomer or polymer B′ comprising reactive ≡SiOH units, characterized in that said dehydrogenative condensation reaction is carried out in the presence of the catalytic complex C defined according to one of claims 1 to 15 and is optionally initiated by thermal activation.

32. The process for the preparation of a branched polyorganosiloxane as claimed in claim 31, in which the ≡SiH/≡SiOH ratio is greater than 1.
